(19) United States
(12) Patent Application Publication
(10) Pub. No.: US 2025/0010263 A1
(43) Pub. Date: Jan. 9, 2025

(54) SELECTIVE REACTIONS IN MICROREACTOR ARRAYS

(71) Applicant: ILLUMINA, INC., San Diego, CA (US)

(72) Inventors: Boyan BOYANOV, San Diego, CA (US); Rean Silke MUSA, San Diego, CA (US); Anthony FLANNERY, Bainbridge Island, WA (US); Sergio PEISAJOVICH, San Diego, CA (US)

(21) Appl. No.: 18/755,363

(22) Filed: Jun. 26, 2024

Related U.S. Application Data
(60) Provisional application No. 63/512,237, filed on Jul. 6, 2023.

(51) Int. Cl. B01J 19/00

(52) U.S. Cl. CPC B01J 19/0046; B01J 2219/00317; B01J 2219/00713; B01J 2219/00722

(57) ABSTRACT

An microreactor array is provided that includes a plurality of microreactors in a substrate. The plurality of microreactors is in fluid communication with a common fluid delivery channel. Each of the microreactors includes an electrode configured to generate one or more gaseous bubbles that can block reagent access to selected microreactors. A method for selective reactions in a microreactor array is also provide.

### INCORPORATION BY REFERENCE TO RELATED APPLICATION

Any and all applications for which a foreign or domestic priority claim is identified in the Application Data Sheet as filed with the present application are hereby incorporated by reference under 37 CFR 1.57.

### BACKGROUND OF THE INVENTION

### Field

The present technology relates generally to an microreactor array or a method for carrying chemical reactions selectively and in parallel, and more specifically to an microreactor array or a method for providing selective reagent access into a micro-reactor array.

### Description of the Related Art

Many applications in biology benefit from the parallelization of sequential chemical reactions in micro-reactor arrays. For example, DNA synthesis is often performed in 96-well plates where a liquid handling robot delivers the next base to be added to the target. Alternatively, inkjet printers have also been configured to deposit micro-droplets of nucleotides at designated locations. Barcoding DNA samples and/or attaching specific adapters, indices, or other landmarks to sets of DNA inserts during library preparation is another example of an application that uses a similar approach. There is a need for parallelization when using DNA as a medium for storing digital data, particularly during the writing stage when DNA synthesis is employed to mirror “bits-to-bases.”

However, current methods suffer from a common limitation—the reagent delivery is sequential, and thus their plexicities are limited. At low plexicities, sequential reagent delivery using these methods is not a serious limitation, but, as parallelization is increased, the limitations from the overhead of sequential delivery can become substantial. For example, if 100,000 parallel reactions are carried out and the delivery of reagents to each reactor zone takes 0.1 s, then the time overhead for each cycle of the reaction would be 2.7 hrs. A significant delay of time is a limitation associated with massive parallelization with sequential reagent delivery technologies.

Therefore, there is a long-felt need for microreactor arrays and methods that reduce the overhead time of sequential chemical reactions while achieving high plexicities in microreactor arrays, such as an array, microarray, or flow cell.

### SUMMARY

The systems, fluidic devices, and methods disclosed herein each have several aspects, no single one of which is solely responsible for their desirable attributes. Without limiting the scope of the claims, some prominent features will now be discussed briefly. Numerous other embodiments are also contemplated, including embodiments that have fewer, additional, and/or different components, steps, features, objects, benefits, and advantages. The components, aspects, and steps may also be arranged and ordered differently. After considering this discussion, and particularly after reading the section entitled “Detailed Description”, one will understand how the features of the devices and methods disclosed herein provide advantages over other known devices and methods.

The following are examples of certain devices and methods for providing selective reagent access with increased parallelization of sequential chemical reaction in microreactor arrays.

Described herein includes a method for selective reactions in a microreactor array. The method comprises providing an array of microreactors in fluid communication with a common fluid delivery channel, wherein each of the microreactors is associated with a first electrode, followed by flooding the array of microreactors with a first fluid, wherein the first fluid is selected to release a gas upon electrolytic decomposition at the first electrode, then applying a bias to the first electrode associated with one or more selected microreactors in the array, thereby forming one or more gaseous bubbles at or near the first electrode. The method further includes flushing the array of microreactors with a second fluid, wherein the one or more gaseous bubbles blocks the second fluid from accessing the one or more selected microreactors in the array, and carrying out a reaction in the microreactors that are not blocked by the one or more gaseous bubbles.

In some embodiments, the first fluid comprises an electrolyte. In some embodiments, the second fluid comprises a reagent.

In some embodiments, the method further comprising flushing the array of microreactors with a third fluid selected to dissolve the one or more gaseous bubbles blocking the one or more selected microreactors in the array. In some embodiment, the third fluid comprises a deblocking agent.

In some embodiments, the method further comprises turning off the bias to the first electrode associated with the one or more selected microreactors, thereby allowing the one or more gaseous bubbles to shrink or dissolve in the second fluid.

In some embodiments, each of the microreactors in the array comprises a well. In some embodiments, the one or more gaseous bubbles reside in the well of the one or more selected microreactors in the array.

In some embodiments, the array of microreactors further comprises one or more reaction zones, and each reaction zone comprises a plurality of wells. In some embodiments, the one or more gaseous bubbles reside in a selected reaction zone.

In some embodiments, each of the microreactors in the array is connected to a common fluid delivery channel via an access channel. In some embodiments, the first electrode is disposed in the access channel.

Described herein also includes a method for selective reactions in a microreactor array. The method comprises providing a microreactor array comprising two or more reaction zone, wherein each reaction zone comprises a plurality of microreactors, a common fluid delivery channel in fluid communication with the two or more reaction zones and the plurality of microreactors, and wherein each of the reaction zone is associated with a second electrode, and optionally each of the microreactors is associated with a first electrode. The method further comprises flooding the microreactor array with a first fluid, wherein the first fluid is selected to release a gas upon electrolytic decomposition at the first electrode or at the second electrode, then applying a bias to the second electrode associated with one or more selected reaction zones or the first electrode associated with one of more of the plurality of microreactors in the selected reaction zone, thereby forming one or more gaseous bubbles in the selected reaction zone, then flushing the microreactor array with a second fluid, wherein the one or more gaseous bubbles blocks the second fluid from accessing the plurality of microreactors in the selected reaction zone, and carrying out a reaction in the microreactors that are not blocked by the one or more gaseous bubbles.

In some embodiments, the first fluid comprises an electrolyte. In some embodiments, the second fluid comprises a reagent.

In some embodiments, the method further comprising flushing microreactor array with a third fluid selected to dissolve the one or more gaseous bubbles in the selected reaction zone. In some embodiment, the third fluid comprises a deblocking agent.

In some embodiments, the method further comprising turning off the bias to the first electrode and the second electrode, thereby allowing the one or more gaseous bubbles to shrink or dissolve in the second fluid.

Described herein includes a microreactor array comprising a plurality of microreactors in a substrate, wherein the plurality of microreactors is in fluid communication with a common fluid delivery channel, a first electrode associated with each of the plurality of microreactors, and wherein the first electrode is configured to generate one or more gaseous bubbles via electrolytic decomposition of a first fluid.

In some embodiments, each of the plurality of microreactors comprises a well having a dimension for trapping the one or more gaseous bubbles in the microreactor. In some embodiments, the first electrode is disposed in the well.

In some embodiments, the microreactor array further comprises two or more reaction zones, wherein each reaction zone comprises two or more of the plurality of microreactors. In some embodiments, each of the reaction zones further comprises a second electrode. In some embodiments, each of the reaction zones has a dimension for trapping the one or more gaseous bubbles in the reaction zone. In some embodiments, the first electrode is disposed in the reaction zone.

In some embodiments, the microreactor array further comprises an access channel connecting each of the plurality of microreactors to the common fluid delivery channel. In some embodiments, the first electrode is disposed in the access channel. In some embodiments, the first fluid comprises an electrolyte.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIGS. 1A-1D schematically illustrate an embodiment of a microreactor array steps for generating bubbles by way of electrolysis according to some embodiments.

FIG. 2 schematically illustrates an embodiment of microreactor array capable of generating bubbles by way of electrolysis according to some embodiments.

FIGS. 3A and 3B schematically illustrate the top-view of embodiments of a fluidic microreactor array capable of generating bubbles.

FIG. 4 shows an embodiment of microreactor array configured as a flow cell.

FIGS. 5A-5C schematically illustrate a self-limiting circuit feature according to some embodiments.

FIGS. 6A-6F show an example of a time-lapse formation of bubble(s) in a well of a microreactor array via electrolysis according to some embodiments.

FIGS. 7A-G schematically illustrate one embodiment of a method of using the bubbles to selectively block certain microreactors from reagents.

### DETAILED DESCRIPTION

All patents, applications, published applications and other publications referred to herein are incorporated herein by reference to the referenced material and in their entireties. If a term or phrase is used herein in a way that is contrary to or otherwise inconsistent with a definition set forth in the patents, applications, published applications and other publications that are herein incorporated by reference, the use herein prevails over the definition that is incorporated herein by reference.

Disclosed herein includes methods for selective reactions in a microreactor array and microreactors arrays designed to increase the efficiency and scale of multiplexing chemical reactions despite increased parallelization. The disclosed methods eliminate the need for sequential reagent delivery to an array of reaction wells by utilizing a common delivery fluidic supply while controlling reagent access to selected microreactors or selected group of microreactors.

### Microreactor Arrays

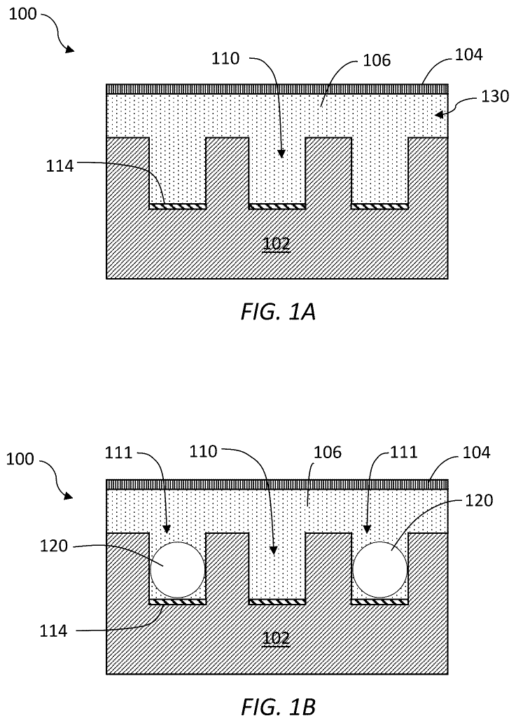

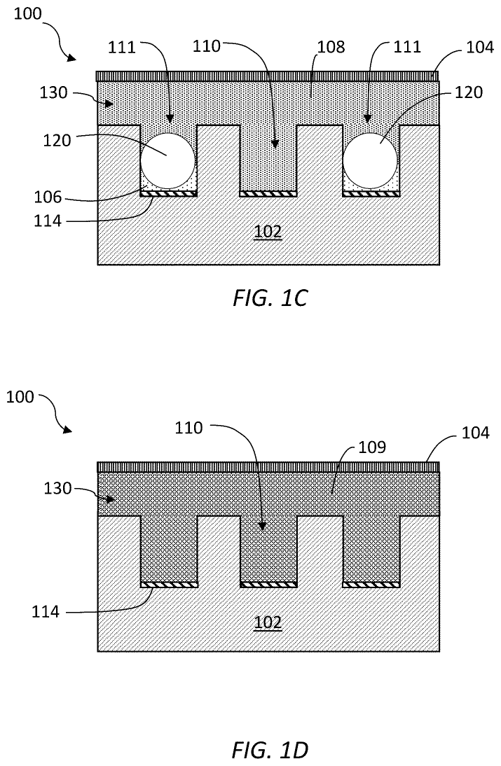

With reference to FIG. 1A, in some embodiments, an microreactor array 100 comprises a plurality of microreactors 110 in a substrate 102, and the plurality of microreactors 110 are in fluid communication with a common fluid delivery channel 130. Various fluids may be delivered to all the microreactors 110 at once (instead of delivery of one fluid to one microreactor at a time). A first electrode 114 is associated with each of the plurality of microreactors 110. The first electrode 114 is configured to generate one or more gaseous bubbles 120 via electrolytic decomposition of a first fluid 106. Electrolytic decomposition of the first fluid 106 can occur under appropriate biasing conditions, where aqueous and non-aqueous electrolyte decompose into gaseous phase. In some embodiments, the first electrode 114 comprises aluminum, nickel, chromium, gold, germanium, copper, silver, titanium, tungsten, platinum, tantalum, polycrystalline materials, alloys thereof, and combinations thereof, or any combination thereof. In some embodiments, the electrolyte may comprise deionized water, potassium formate, NaCl (will produce Cl₂ instead of O₂ bubbles), CHKO₂, or sodium bicarbonate. The substrate 102 suitable for making the microreactor array 100 may comprise any suitable substrates, such as semiconductor wafers, glass substrates, polymer substrates, or other suitable substrates. The substrate 102 may comprise additional layers formed thereover such as dielectric layers, such as oxides, nitrides, photoresist (e.g., SU₈ polymer), polymers (e.g., PAZAM), other suitable dielectric layers, and combinations thereof. The substrate 102 may include features formed therein, such as through etching, photolithography, and nano-imprint lithograph.

In some embodiments, each of the microreactors 110 in the array is shaped as a well in the substrate 102. In some embodiments, the well has a dimension that is capable of trapping generated gaseous bubble or bubbles 120 in the well. For example, the well may have a cross-sectioning length of about 50 nanometers to about 500 micrometers. The methods and systems set forth herein may use arrays having features at any of a variety of densities including, for example, at least about 10 features/cm², about 100 features/cm², about 500 features/cm², about 1,000 features/cm², about 5,000 features/cm², about 10.000 features/cm², about 50.000 features/cm², about 100,000 features/cm², about 1,000,000 features/cm², about 5,000,000 features/cm², or higher. The methods and apparatus set forth herein may include detection components or devices having a resolution that is at least sufficient to resolve individual features at one or more of these densities.

In some embodiments, the first electrode 114 is disposed in the well, and the gaseous bubble(s) 120 may be generated at or near the first electrode 114. A gaseous bubble 120 may be start growing within the well until it is as large as the diameter of the well, which would block the current flow between the counter electrode 104 and the first electrode 114 and stop the growth of the bubble. It is not necessary for each well to be blocked by a single well-formed bubble, as multiple bubbles can also block the fluid access to the well. Thus in some embodiments, two or more bubbles may be present in the well that block the fluid access to the well.

In some embodiments, the microreactor array 100 may include at least 48, at least 96, at least 384, at least 1,536, at least 3,456, or at least 9600 individual microreactors. In some embodiments, the microreactor array 100 may include at least 96,000, at least 100,000 pr at least 1,000,000 individual microreactors.

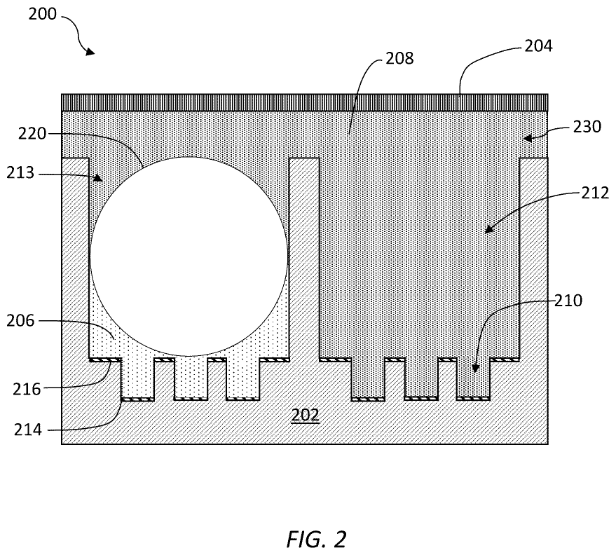

In some embodiments, hierarchical implementations can be done where two or more microreactors are batched into a group that requires the same access or the same reaction sequence. Multilayer structures in a substrate 202 can be formed with semiconductor fabrication techniques to enable more complex grouping of the microreactors. For example, as shown in FIG. 2, the microreactor array 200 includes two or more reaction zones 212, and each reaction zone 212 contains a group of microreactors 210. A common fluid delivery channel 230 is in fluid communication with the reaction zones 212 and the plurality of microreactors 210. The fluid access to a group of microreactors 210 may be blocked simultaneously by forming one or more bubbles 220 in the reaction zone 212. In some embodiments, the reaction zone 212 may be associated with a second electrode 216, which can be biased to form the bubble(s) that resides within the selected reaction zone 213 that blocks off the group of microreactors 210 in the selected reaction zone 213. In some embodiments, each of the microreactors may be associated with a first electrode 214. The first electrode 214 may also be biased to form bubble(s).

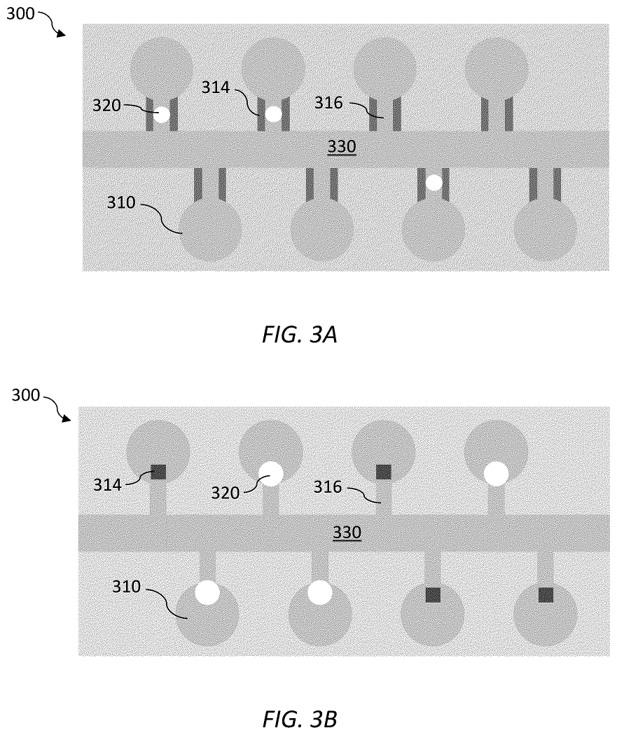

In some embodiments, the plurality of microreactors may be connected to the common fluid delivery channel via an access channel. For example, the fluid can flow from a common fluid delivery channel to individual microreactors through an access channel in a flow cell configuration. With reference to FIG. 3A, looking down over the top of one embodiment of microreactor array, each one of a plurality of microreactors 310 is in fluid communication with a common fluid delivery channel 330 via an access channel 316. In some embodiments, the access channel is equipped with a first electrode 314, which is individually accessible. A bubble or bubbles 320 may be formed in the access channel 316 when a bias is applied, which serves to block of further fluid access to the microreactor 310 that is connected to that access channel 316. In some embodiments, the placement of the first electrode may be inside of the microreactors 310. FIG. 3B shows another embodiment of a microreactor array 300 where the first electrodes are located in the microreactors 310 at or near the connection of the microreactor 310 to the access channel 316. In such embodiment, a bubble or bubbles 320 may be formed at or near the first electrode 314 located in the microreactor 310, which can grow to block the fluid access at the connection of the microreactor 310 to the access channel 316. In some embodiments, such embodiments may be incorporated into a flow cell design.

In some embodiments, a group of microreactors in the flow cell may also be batched into multiple reaction zones. A reaction zone may be connected to the common fluid delivery channel via an access channel. Similarly, a bubble or bubbles may be formed in the access channel or at the connection of the reaction zone to the access channel and block further fluid access to the group of microreactors in the selected reaction zone.

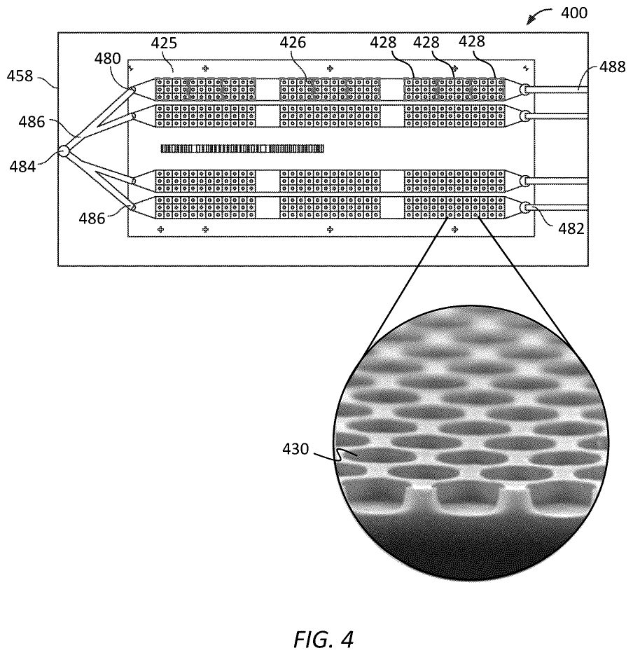

FIG. 4 is a non-limiting example of a flow cell that contains a microreactor array with a hierarchical implementation and configuration that allows selective blockage of fluid access to one or more reaction zones. A flow cell 425 with multiple lanes 426 (in this case, 4 lanes) is housed in a cartridge assembly 400. The body 458 of the flow cell cartridge assembly 400 defines the fluid inlet 484, the fluidic lines 486, and the outlets 488. The fluidic lines 486 and outlets 488 are configured to couple to each of the lane inlet 480 and lane outlet 482, respectively. Each flow cell lane 426 may include two or more reaction zones 428, and each reaction zone 428 includes a plurality of microreactors 430 (e.g., wells). Each reaction zone 428 has a first electrode (now shown), and a bias may be applied to one or more individual reaction zones 428 to form a bubble or bubbles that blocks further fluid access to the one or more reaction zones 428. The fluid may be flushed out of the flow cell through the lane outlet 482 and the outlet 488 of the cartridge assembly 400. With this hierarchical implementation, the flow cell is no longer limited to a single sample or a pool of indexed samples per lane, as single sample per lane could be wasteful and indexed samples could be computationally intensive to decouple the pooled samples based on the indices. The patterned wells (i.e. microreactors 430) shown in FIG. 4 may be arranged in any order, such as hexagonal or in a grid. FIG. 4 shows nine reaction zones in one of the lanes, but any number of reaction zones may be implemented.

One advantage of this approach is massive parallelism with quick reaction cycles, as fluidic exchanges in a flow cell configuration containing millions of wells takes less than a few minutes, and the bubble formation will take a few seconds to a few tens of seconds. This is much faster than what is achievable by liquid handling robots or in-jet printers that utilize sequential delivery of liquid.

### Method for Selective Reactions

A method for selective reactions in a microreactor array 100 is disclosed. With reference to FIG. 1A, the method includes flooding the array of microreactors 110 with a first fluid 106 selected to release a gas upon electrolytic decomposition at the first electrode 114. A ground electrode 104 forms a circuit with the first electrode 114 when the microreactor array is flooded with the first fluid 106. A control unit (not shown) may be configured to control biasing of each of the first electrodes 114 associated with each microreactors 110.

Next step, as shown in FIG. 1B, involves applying a bias to the first electrode 114 of the selected microreactor(s) 111 that need to be isolated/blocked from the next reaction step. The applied bias drives the electrolysis of the first fluid 106, causing the gas to be released from the first fluid 106 at or near the first electrode 114. The gas released during electrolysis forms a bubble or bubbles 120 that is/are trapped inside the selected microreactors 111. When a bias is applied to the first electrode 114 in associated with a selected reaction zone 111, the bubble(s) 120 forms and grows to a point where the fluid access to the selected reaction zone 111 is blocked. In some embodiments, formation of a bubble(s) 120 sufficiently large to block the selected microreactor(s) may take a few seconds to a few tens of seconds. In some embodiments, biasing is controlled for each individual first electrode 114. Accordingly, individual or different combinations of the first electrodes 114, and thus individual microreactors 110 or different combinations of microreactors 110, may be selected to proceed with a reaction, and other combinations or individual microreactors 111 may be selected for bubble formation.

In some embodiments, the bubble 120 comprises a plurality of bubbles. Therefore, it is not necessary for each microreactors 110 to be blocked by a single well-formed bubble 120. A plurality of bubbles is adequate so long as fluidic access to the microreactors 110 is blocked. Under appropriate biasing conditions, the first fluid 106 (aqueous and non-aqueous) decomposes to release a gas, which results in formation of the bubble 120. In one non-limiting example, H₂O can undergo electrolytic decomposition: Cathode (reduction): 2H₂O (l)+2e⁻→H₂(g)+2OH⁻(aq); Anode (oxidation): 2OH⁻(aq)→½O₂ (g)+H₂O(l)+2e⁻. In some embodiments, the first fluid 106 comprises DIH₂O. In some embodiments, the first fluid 106 comprises metallic formates, e.g., CHKO₂. In some embodiments, the first fluid 106 comprises NaCl. In some embodiments, the first fluid 106 comprises NaHCO₃. In some embodiments, the first fluid 106 comprises DIH₂O, CHKO₂, NaCl, NaHCO₃, or any combination thereof.

With reference to FIG. 1C, once the access to the selected microreactors 111 is blocked, a second fluid 108 may be introduced to the microreactor array 100 to replace the first fluid 106, and only the accessible microreactors 110 that are not blocked by a bubble or bubbles 120 would receive the second fluid 108. The second fluid 108 may be a reagent for carrying out a chemical reaction in the accessible microreactors 110. The desired reaction may occur in one or more accessible microreactors 110 not blocked by a bubble or bubbles 120. This allows the delivery of the second fluid 108 to all the accessible microreactors 110 almost simultaneously or within a very short period of time. Among those reaction zones 110 that remain unblocked, the chemical reaction may proceed in parallel.

In some embodiment, a third fluid 109 may be used to deblock the selected microreactors. The microreactor array 100 may be flushed by the third fluid 109 after the reaction in the accessible microreactors 110 have been completed. The third fluid 109 is selected to dissolve the one or more gaseous bubbles 120 blocking the selected microreactors 111 in the array, thereby allowing subsequent fluid access to the microreactors (see FIG. 1D). In some embodiments, the third fluid 109 includes a deblocking agent. Preferably, the deblocking agent exhibits high miscibility with the bubble(s) 120 and high solubility in water, such as polar solvents. Examples of polar solvents include isopropanol, n-butanol, ethanol, methanol, 1-propanol, tetrahydrofuran, acetaldehyde, acetic acid, acetone, acetonitrile, ethylamine, propanoic acid, and other suitable solvents. In some embodiments, the deblocking agent may include a liquid. In some embodiments, the deblocking agent comprises isopropanol as isopropanol may dissolve CO₂ bubbles. In some embodiments, the deblocking agent comprises ethanol. The third fluid 109 (such as a deblocking agent) is flown over the substrate 102, contacts the bubble(s) 120, and proceeds to dissolve or shrink the bubble(s) 120. After the fluid access to the block microreactors 111 is restored, the deblocking agent may be flushed from the array and, thereafter, the first fluid 106 may be added to start block other microreactors.

In some embodiments, dissolution of gas into the second fluid 108 may be used to control removal of one or more blocking bubbles 120. The gas in the bubble 120 may be highly soluble in water, wherein the gas may be dissolved into the second fluid 108 over time, thereby effectuating the removal of the one or more blocking bubbles 120. In some embodiments, bubbles formed by CO₂(g) or H₂(g) may be dissolved into the second fluid 108 and result in the removal or partial removal of the one or more blocking bubbles 120. In some embodiments, one or more blocking bubbles 120 can thus be removed without requiring a liquid exchange (and involving the use of a deblocking agent), thereby saving time and resources, and increasing the efficiency and flexibility for multiplexing reactions. In some embodiments, a liquid exchange may be performed to remove the one or more blocking bubbles 120.

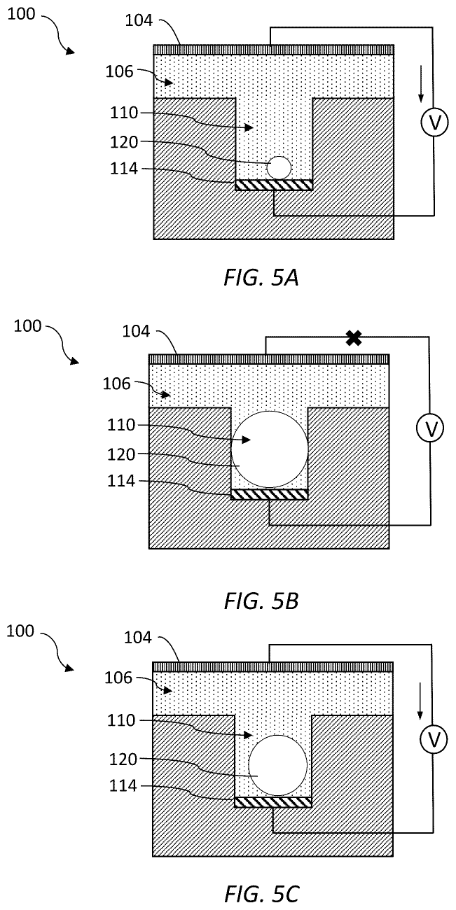

In some embodiments, the electrochemical reaction that forms the bubble 120 may be self-terminating. As shown in FIG. 5A, the bubble 120 grows as electrolysis causes the release of the gas when the bias is applied to the first electrode 114. When the bubble 120 grows big enough to block off the fluid access to the first electrode as shown in FIG. 5B, the bubble itself can disrupt the circuit flow between the two electrodes, which results in the electrolysis current being blocked off even if the bias on the first electrode 114 is maintained by the voltage source. This self-terminating feature of the microreactor array 100 removes the need for additional, and more complicated, monitoring and control of the current generation through the circuit.

Additionally, as shown in FIGS. 5B and 5C, the bubble formation is self-regulating. If the bias on the electrode 114 is maintained and the bubble 120 shrinks (as the gas dissolves back into the fluid) to a size that no longer completely blocks microreactor 110, as shown in FIG. 5C, the circuit is formed again and the electrochemical reaction can resume and regrow the bubble 120 until the bubble 120 is large enough to block the microreactor 110, as shown in FIG. 5B, which blocks off the electrolytic current and disrupts the circuit again. On the other hand, switching off the bias on the electrode 114 of certain microreactor 110 can lead to the bubbles 120 being dissolved and the microreactor 110 becoming unblocked. As such, each individual microreactor can be selectively blocked or unblocked by controlling the bias applied to the electrode associated with the individual microreactor.

In some embodiments, the bubbles in multiple microreactors may be independently removed (e.g., destroyed/dissolved) and regenerated to unblock or block the microreactors as needed. In some embodiments, de novo oligonucleotide synthesis can be conducted in different microreactors where the reactions in each microreactor can be individually controlled. Parallel reactions can take place to generate individual polynucleotide of desired sequence and length by controlled blocking and unblocking of the microreactors using bubbles. One example of selective parallel reaction includes selective incorporation of certain nucleotide to the growing strands in selected microreactors. Each cycle of A, T, C, or G nucleotide incorporation can take place at the same time in microreactors that are exposed and have a polynucleotide strand with an unblocked terminator by flowing in modified free floating nucleotides (A, T, C, or G) with a reversible blocked terminator. Another example of selective parallel reaction involves unblocking the microreactors where a reaction is desirable, such as flowing in a cleave mix to cleave the reversible terminator of a polynucleotide strand in selected exposed microreactors and allowing further incorporation of nucleotide to occur.

In some embodiments, the method described herein can be applied to forming a bubble or bubbles in a reaction zone where a group of microreactors are batched under hierarchical implementations. With reference to FIG. 2, in some embodiments, a bias may be applied to the second electrode 216 associated with the selected reaction zone 213 after the microreactor array 200 has been flooded with the first fluid 206. The bubble or bubbles 220 would grow and be trapped inside of the selected reaction zone 213 until the bubble(s) become large enough to block further fluid access to the microreactors 210 within the selected reaction zone 213. In some embodiments, a bias may be applied to the first electrode 214 associated with one or more of the microreactors. One or more bubbles may be formed at or near the first electrode(s) 214 and get pushed out into and trapped in the selected reaction zone 213, which serves the purpose of blocking the fluid access to all the microreactors 210 in the selected reaction zone 213. In some embodiments, the second electrode 216 may comprises platinum, rhodium, ruthenium, iridium, silver, nickel, cobalt, copper, 304 stainless steel, nickel-iron, or any combination thereof.

Once the selected reaction zone 213 has been blocked by the bubble(s) 220, the second fluid 208 may be introduced and to replace the first fluid 206 in the unblocked reaction zone 212 and the microreactors 210 in it for carrying out a reaction. In some embodiments, the microreactor array 200 may be flushed with the third fluid (now shown) that can dissolve the gaseous bubbles in the selected reaction zone 213.

In some embodiments, the method described herein can also be applied to forming a bubble or bubbles in the access channel that connects the microreactors to the common fluid delivery channel or at the connection of the microreactors to the access channels as discussed herein. For example, in microreactor array 300 as shown in FIG. 3A, with the first electrode 314 located in the access channel 316, the bubble(s) may be generated inside of the access channel 316, which blocks further fluid access to the corresponding microreactor 310. In some embodiments, the bubbles may be formed inside of the microreactor at or near the connection to the access channel, thereby blocking the fluid access. For example, in the microreactor array 300 as shown in FIG. 3B, the first electrode 314 may be located close to the connection to the access channel 316. When a bias is applied to the first electrode 314 of one or more selected microreactors, bubble(s) would form at or near the first electrode 314 and block off the entry to the microreactor 310 at the connection to the access channel 316.

### EXAMPLE

### Example 1

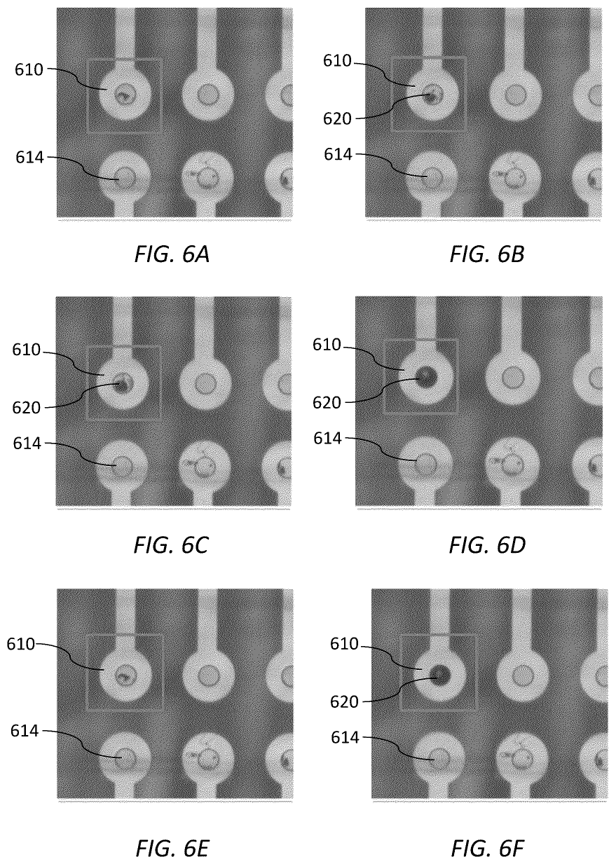

FIGS. 6A-6D illustrate the formation of one or more blocking bubbles from t0 to t3 in one of the microreactors 610 in a microreactor array 600. As shown, the one or more blocking bubbles 620 formed and grew at the electrode 614 when a bias of about 1.2V is applied to one of the electrodes 614 for a duration from t0 (FIG. 6A) to t3 (FIG. 6D). The at least one bubbles 620 grows inside of the well of the microreactor 610 until the well is blocked as shown in FIG. 6D. Subsequently, a deblocking agent, isopropanol, was introduced to the array 600, with resulted in the one or more blocking bubbles 620 being removed. As seen in FIG. 6E, the bubble(s) that were blocking the well had disappeared and the microreactor 610 was again available for the next reaction cycle. The bubble forming process may be repeated when preventing further fluid access is needed bias by re-applying the bias to the electrode 614 to reform the one or more blocking bubbles 620 as shown in FIG. 6F.

### Example 2

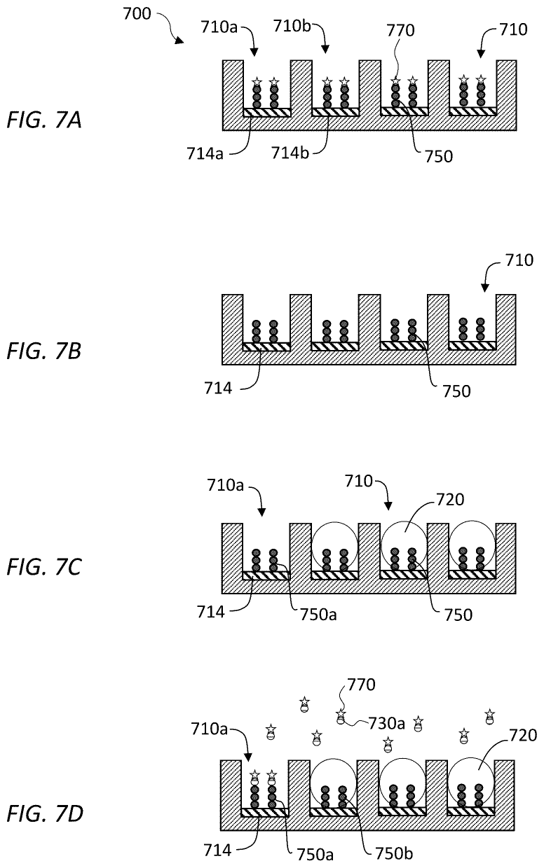

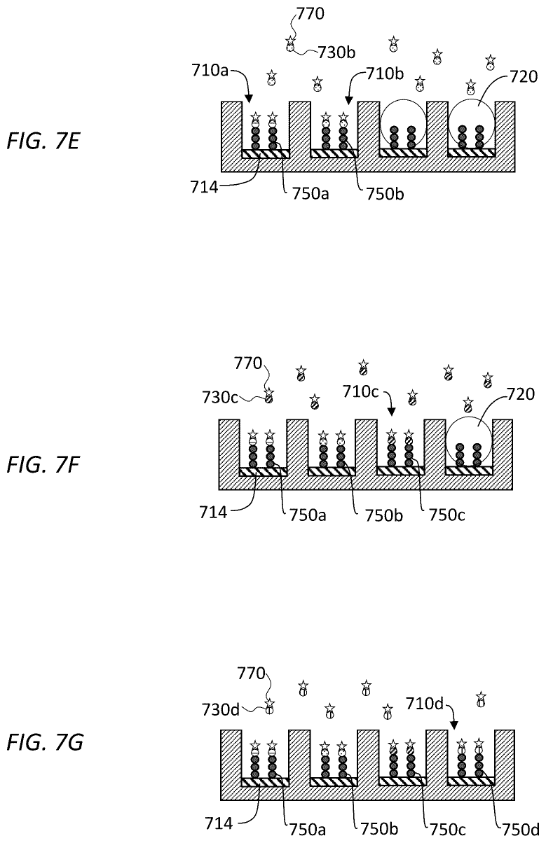

As demonstrated in FIG. 7A, bubbles can be generated to block a specific microreactor wells from access to a reagent a large-scale de novo oligo synthesis. The bubbles can be independently destroyed/dissolved and regenerated, such as to blocked and de-blocked the reagent access to a specific microreactor. The apparatus and method can be applied so that each microreactor's reactions can be independently controlled by parallel reactions place to generate an individual polynucleotide of a desired sequence and desired length. A microarray 700 is provided with a plurality of microreactors 710a, 710b, etc. each with an independently controllable electrode 714a, 714b, etc. Each microreactor 710 contains one or more reactive entities 750 adhered to or bound with the microreactor 710, such as a seed, a primer strand, or other reactive entity.

For example, in one embodiment, as shown in FIG. 7A, each of the microreactors 710 contains one or more reactive entities 750 of oligo primers with a protected 3′ end. For example, the reactive entities 750 are protected with a reversible blocking group 770 or other reversible termination.

As shown in FIG. 7B, all or a plurality of the microreactors 710 can undergo deprotection so 3′ end of the reactive entity 750 is deprotected. For example, the reversible blocking groups 770 are cleaved from reactive entity 750, such as flowing in a cleave mix over the microarray 700.

In the next step as shown in FIG. 7C, a bubble 720 may be generated in each of one or more of the microreactor wells 710, which blocks access to the reactive entities 750 in those microreactors. The microreactor 710a is left unblocked and available for undergoing a reaction step.

As shown in FIG. 7D, while access to the reactive entities 750 of the microreactors 710 is blocked by the bubble 720, modified free-floating nucleotides (FFNs) 730a are flowed over the microarray 700. For example, the modified FFNs 730a flowed in are a single type of base, such as adenine, cytosine, guanine, or thymine. The modified FFNs 730a are modified with a reversible terminator 770. The modified FFNs 730a may be flowed in with a polymerase, such as a template independent DNA polymerase of TdT or another suitable polymerase. Since the modified FFNs 730a include a reversible terminator 770, the oligos of microreactor 710a are extended by a single base. Since access of the other microreactors 710 is blocked by the bubbles 720, the reactants cannot access these microreactor 710 and therefore the oligo of microreactors 710 blocked by bubbles will not be extended.

As shown in FIG. 7E, the bubble 720 blocking access to reactive entity 750b of the microreactor 710b is dissolved. A different type of modified free-floating nucleotides (FFNs) 730b than one FFNs used in the step in FIG. 7D (730a) are flowed over the microarray 700. For example, the modified FFN 730b flowed in are a single type of base, such as adenine, cytosine, guanine, or thymine. The modified FFNs 730b are modified with a reversible terminator 770. The modified FFNs 730b may be flowed in with a polymerase, such as a template independent DNA polymerase of TdT or another suitable polymerase. Since the modified FFNs 730b include a reversible terminator 770, the oligos of microreactor 710b are extended by a single base. Since the reactive entity 750a of microreactor 710a has a protected 3′ end, the oligo of microreactor 710a will also not be extended.

In FIG. 7E, bubbles in one or more other microreactors may be dissolved to allow access to the next reagent. For example, the bubble 720 blocking the access to reactive entity 750c of the microreactor 710c is dissolved. Yet another different type of modified free-floating nucleotides (FFNs) 730c are flowed over the microarray 700. For example, the modified FFN 730c flowed in are a single type of base, such as adenine, cytosine, guanine, or thymine. The modified FFNs 730c are modified with a reversible terminator 770. The modified FFNs 730c may be flowed in with a polymerase, such as a template independent DNA polymerase of TdT or another suitable polymerase. The modified FFNs 730c are also modified with a reversible terminator 770, thus the oligos of microreactor 710c are extended by a single base. Since the reactive entities 750a and 750b of microreactor 710a and 710b have a protected 3′ end, the oligos of microreactors 710a and 710b will also not be extended.

Similarly in FIG. 7G, bubbles in one or more other microreactors may be dissolved to allow access to the next reagent. For example, the bubble 720 blocking the access to reactive entity 750d of the microreactor 710d is dissolved. Yet another different type of modified free-floating nucleotides (FFNs) 730d are flowed over the microarray 700. For example, the modified FFN 730b flowed in are a single type of base, such as adenine, cytosine, guanine, or thymine. The modified FFNs 730d are modified with a reversible terminator 770. The modified FFNs 730d may be flowed in with a polymerase, such as a template independent DNA polymerase of TdT or another suitable polymerase. The modified FFNs 730d are also modified with a reversible terminator 770, thus the oligos of microreactor 710d are extended by a single base. Since the reactive entities 750a, 750b, and 750c of microreactor 710a, 710b, and 710c have a protected 3′ end, the oligos of microreactors 710a, 710b, and 710c will not be extended.

The reaction steps demonstrated in FIGS. 7A-7G may be repeated to synthesize an oligo in parallel reactions to do de novo oligo synthesis of an oligo to any desired sequence or size. In some embodiments the synthesized oligos from each well may be of the same or different lengths.

### Definitions

All technical and scientific terms used herein have the same meaning as commonly understood to one of ordinary skill in the art to which this disclosure belongs unless clearly indicated otherwise.

As used herein, the singular forms “a”, “and”, and “the” include plural referents unless the context clearly dictates otherwise. Thus, for example, reference to “a sequence” may include a plurality of such sequences, and so forth.

The terms comprising, including, containing and various forms of these terms are synonymous with each other and are meant to be equally broad. Moreover, unless explicitly stated to the contrary, examples comprising, including, or having an element or a plurality of elements having a particular property may include additional elements, whether or not the additional elements have that property.

As used herein, the terms “fluidically connecting,” “fluid communication,” “fluidically coupled,” and the like refer to two spatial regions being connected together such that a fluid (e.g., liquid or gas) may flow between the two spatial regions. For example, a reaction zone may be fluidically connected to a common fluid channel by way of a microfluidic channel, such that a fluid, e.g., at least a portion of an electrolyte, may flow between the reaction zone and the common fluid channel.

As used herein, a “nucleotide” includes a nitrogen containing heterocyclic base, a sugar, and one or more phosphate groups. Nucleotides are monomeric units of a nucleic acid sequence. Examples of nucleotides include, for example, ribonucleotides or deoxyribonucleotides. In ribonucleotides (RNA), the sugar is a ribose, and in deoxyribonucleotides (DNA), the sugar is a deoxyribose, i.e., a sugar lacking a hydroxyl group that is present at the 2′ position in ribose. The nitrogen containing heterocyclic base can be a purine base or a pyrimidine base. Purine bases include adenine (A) and guanine (G), and modified derivatives or analogs thereof. Pyrimidine bases include cytosine (C), thymine (T), and uracil (U), and modified derivatives or analogs thereof. The C-1 atom of deoxyribose is bonded to N-1 of a pyrimidine or N-9 of a purine. The phosphate groups may be in the mono-, di-, or tri-phosphate form. These nucleotides are natural nucleotides, but it is to be further understood that non-natural nucleotides, modified nucleotides or analogs of the aforementioned nucleotides can also be used.

The term “nucleic acid” or “polynucleotide” refers to a deoxyribonucleotide or ribonucleotide polymer in either single- or double-stranded form, and unless otherwise limited, encompasses known analogs of natural nucleotides that hybridize to nucleic acids in manner similar to naturally occurring nucleotides, such as peptide nucleic acids (PNAs) and phosphorothioate DNA. Unless otherwise indicated, a particular nucleic acid sequence includes the complementary sequence thereof. Nucleotides include, but are not limited to, ATP, dATP, CTP, dCTP, GTP, dGTP, UTP, TTP, dUTP, 5-methyl-CTP, 5-methyl-dCTP, ITP, dITP, 2-amino-adenosine-TP, 2-amino-deoxyadenosine-TP, 2-thiothymidine triphosphate, pyrrolo-pyrimidine triphosphate, and 2-thiocytidine, as well as the alphathiotriphosphates for all of the above, and 2′-O-methyl-ribonucleotide triphosphates for all the above bases. Modified bases include, but are not limited to, 5-Br-UTP, 5-Br-dUTP, 5-F-UTP, 5-F-dUTP, 5-propynyl dCTP, and 5-propynyl-dUTP.

The aspects and examples set forth herein and recited in the claims can be understood in view of the above definitions.

### Additional Notes

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

It is to be understood that the ranges provided herein include the stated range and any value or sub-range within the stated range, as if such value or sub-range were explicitly recited. For example, a range from about 2 nm to about 20 nm should be interpreted to include not only the explicitly recited limits of from about 2 nm to about 20 nm, but also to include individual values, such as about 3.5 nm, about 8 nm, about 18.2 nm, etc., and sub-ranges, such as from about 5 nm to about 10 nm, etc. Furthermore, when “about” and/or “substantially” are/is utilized to describe a value, this is meant to encompass minor variations (up to +/−10%) from the stated value.

While several examples have been described in detail, it is to be understood that the disclosed examples may be modified. Therefore, the foregoing description is to be considered non-limiting.

While certain examples have been described, these examples have been presented by way of example only and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, or example are to be understood to be applicable to any other aspect or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing examples. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations, one or more features from a claimed combination can, in some cases, be excised from the combination, and the combination may be claimed as a sub-combination or variation of a sub-combination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some examples, the actual steps taken in the processes illustrated and/or disclosed may differ from those shown in the figures. Depending on the example, certain of the steps described above may be removed or others may be added. Furthermore, the features and attributes of the specific examples disclosed above may be combined in different ways to form additional examples, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular example. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain examples include, while other examples do not include, certain features, elements, and/or steps. Thus, such conditional language is not generally intended to imply that features, elements, and/or steps are in any way required for one or more examples or that one or more examples necessarily include logic for deciding, with or without user input or prompting, whether these features, elements, and/or steps are included or are to be performed in any particular example.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain examples require the presence of at least one of X, at least one of Y, and at least one of Z.

Language of degree used herein, such as the terms “approximately,” “about,” “generally,” and “substantially” represent a value, amount, or characteristic close to the stated value, amount, or characteristic that still performs a desired function or achieves a desired result.

As used herein, the term “plurality” is intended to mean a population of two or more different members. Pluralities may range in size from small, medium, large, to very large. The size of small plurality may range, for example, from a few members to tens of members. Medium sized pluralities may range, for example, from tens of members to about 100 members or hundreds of members. Large pluralities may range, for example, from about hundreds of members to about 1000 members, to thousands of members and up to tens of thousands of members. Very large pluralities may range, for example, from tens of thousands of members to about hundreds of thousands, a million, millions, tens of millions and up to or greater than hundreds of millions of members. Therefore, a plurality may range in size from two to well over one hundred million members as well as all sizes, as measured by the number of members, in between and greater than the above example ranges. Example polynucleotide pluralities include, for example, populations of about 1×10⁵ or more, 5×10⁵ or more, or 1×10⁶ or more different polynucleotides. Accordingly, the definition of the term is intended to include all integer values greater than two. An upper limit of a plurality may be set, for example, by the theoretical diversity of polynucleotide sequences in a sample.

The scope of the present disclosure is not intended to be limited by the specific disclosures of preferred examples in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A method for selective reactions in a microreactor array comprising:
providing an array of microreactors in fluid communication with a common fluid delivery channel, wherein each of the microreactors is associated with a first electrode;
flooding the array of microreactors with a first fluid, wherein the first fluid is selected to release a gas upon electrolytic decomposition at the first electrode;
applying a bias to the first electrode associated with one or more selected microreactors in the array, thereby forming one or more gaseous bubbles at or near the first electrode;
flushing the array of microreactors with a second fluid, wherein the one or more gaseous bubbles blocks the second fluid from accessing the one or more selected microreactors in the array; and
carrying out a reaction in the microreactors that are not blocked by the one or more gaseous bubbles.

2. The method of claim 1, wherein the first fluid comprises an electrolyte.

3. The method of claim 1, wherein the second fluid comprises a reagent.

4. The method of claim 1, further comprising flushing the array of microreactors with a third fluid selected to dissolve the one or more gaseous bubbles blocking the one or more selected microreactors in the array.

5. The method of claim 4, wherein the third fluid comprises a deblocking agent.

6. The method of claim 1, further comprising turning off the bias to the first electrode associated with the one or more selected microreactors, thereby allowing the one or more gaseous bubbles to shrink or dissolve in the second fluid.

7. The method of claim 1, wherein each of the microreactors in the array comprises a well.

8. The method of claim 7, wherein the one or more gaseous bubbles reside in the well of the one or more selected microreactors in the array.

9. The method of claim 7, wherein the array of microreactors further comprises one or more reaction zones, and each reaction zone comprises a plurality of wells.

10. The method of claim 9, wherein the one or more gaseous bubbles reside in a selected reaction zone.

11. The method of claim 1, wherein each of the microreactors in the array is connected to a common fluid delivery channel via an access channel.

12. The method of claim 11, wherein the first electrode is disposed in the access channel.

13. The method of claim 12, wherein the one or more gaseous bubbles are formed in the access channel.

14. A method for selective reactions in a microreactor array comprising:
providing a microreactor array comprising:
two or more reaction zones, wherein each reaction zone comprises a plurality of microreactors;
a common fluid delivery channel in fluid communication with the two or more reaction zones and the plurality of microreactors; and
wherein each of the reaction zones is associated with a second electrode, and optionally each of the microreactors is associated with a first electrode;
flooding the microreactor array with a first fluid, wherein the first fluid is selected to release a gas upon electrolytic decomposition at the first electrode or at the second electrode;
applying a bias to the second electrode associated with one or more selected reaction zones or the first electrode associated with one of more of the plurality of microreactors in the one or more selected reaction zones, thereby forming one or more gaseous bubbles in the one or more selected reaction zones;
flushing the microreactor array with a second fluid, wherein the one or more gaseous bubbles blocks the second fluid from accessing the plurality of microreactors in the one or more selected reaction zones; and
carrying out a reaction in the microreactors that are not blocked by the one or more gaseous bubbles.

15. The method of claim 14, wherein the first fluid comprises an electrolyte.

16. The method of claim 14, wherein the second fluid comprises a reagent.

17. The method of claim 14, further comprising flushing the microreactor array with a third fluid selected to dissolve the one or more gaseous bubbles in the one or more selected reaction zones.

18. The method of claim 17, wherein the third fluid comprises a deblocking agent.

19. The method of claim 14, further comprising turning off the bias to the first electrode and the second electrode, thereby allowing the one or more gaseous bubbles to shrink or dissolve in the second fluid.

20. A microreactor array comprising:
a plurality of microreactors in a substrate, wherein the plurality of microreactors are in fluid communication with a common fluid delivery channel;
a first electrode associated with each of the plurality of microreactors; and
wherein the first electrode is configured to generate one or more gaseous bubbles via electrolytic decomposition of a first fluid.

21. The microreactor array of claim 20, wherein each of the plurality of microreactors comprises a well having a dimension for trapping the one or more gaseous bubbles in the microreactor.

22. The microreactor array of claim 21, wherein the first electrode is disposed in the well.

23. The microreactor array of claim 20, further comprising two or more reaction zones, wherein each reaction zone comprises two or more of the plurality of microreactors.

24. The microreactor array of claim 23, wherein each of the reaction zones further comprises a second electrode.

25. The microreactor array of claim 23, wherein each of the reaction zones has a dimension for trapping the one or more gaseous bubbles in the reaction zone.

26. The microreactor array of claim 25, wherein the first electrode is disposed in the reaction zone.

27. The microreactor array of claim 20, further comprising an access channel connecting each of the plurality of microreactors to the common fluid delivery channel.

28. The microreactor array of claim 27, wherein the first electrode is disposed in the access channel.

29. The microreactor array of claim 20, wherein the first fluid comprises an electrolyte.
